(19) United States
(12) Patent Application Publication
(10) Pub. No.: US 2008/0107099 A1
(43) Pub. Date: May 8, 2008

(54) System and method for adapting a transport stream for transmission

(76) Inventor: Alex Dolgonos, Thornhill (CA)

Correspondence Address: PIETRAGALLO GORDON ALFANO BOSICK & RASPANTI LLP, ONE OXFORD CENTRE, 38TH FLOOR, 301 GRANT STREET, PITTSBURGH, PA, 15219-6404, US

(21) Appl. No.: 11/592,547

(22) Filed: Nov. 3, 2006

(51) Int. Cl. H04J 3/24; H04J 3/06

(52) U.S. Cl. 370/349; 370/350

(57) ABSTRACT

An ASI transport stream is processed in a way that allows the use of an RF wireless link to connect a distribution network to a transmitter in a single-frequency network. Null packets are disguised by changing the PID value of each null packet to a PID value that has been arranged to designate null packets. Each packet that contains a PCR stamp is amended to hide the presence of the PCR stamp. As a result, none of the packets in the transport stream are recognized, by elements of the RF link, as a null packet or as a packet containing a PCR stamp. Accordingly, such packets are considered, by elements of the RF link, to be packets carrying payload. Advantageously, then, packets that would normally be removed or modified by elements of the RF link pass through without being removed or modified.

### FIELD OF THE INVENTION

The present invention relates to digital video broadcasting and, more particularly, to adapting a transport stream for transmission.

### BACKGROUND OF THE INVENTION

Some broadcast systems employ a single omnidirectional broadcast antenna to flood an extensive region with a signal from a single omnidirectional broadcast antenna. Such a single omnidirectional broadcast antenna generally requires a tall transmission tower, so that propagation of the signal will not be impeded by other tall structures in the area. When considered for deployment in urban areas, tall transmission towers may not be cost effective. Thus, a transmission system designer is forced to use a shorter tower installed on a roof top. To enhance broadcast coverage, the system designer may opt to employ “transmit diversity”. One known system that employs transmit diversity is called a single-frequency network.

According to wikipedia.org, a single-frequency network, or “SFN”, is a type of radio network that operates several transmitters on a single frequency. To avoid interference, each station is usually run synchronously with the others. The synchronism is accomplished using a reference clock, which may be obtained from a signal from the known Global Positioning System (GPS), a signal from a main station or a signal from a related data network.

Synchronization of multiple transmission signals to a receiver can prove to be very difficult, particularly in systems that require high bandwidth. Attempts at transmitting, at a repeater, an analog television signal on the same channel as a first transmitter have been known to result in ghosting, since a signal from the repeater reaches the receiver over a second path, distinct from the path over which a signal from the first transmitter reaches the receiver.

The conversion to digital television is expected to allow SFNs to be used reliably for carrying moving images. The conversion is expected to be easiest in systems that use coded orthogonal frequency-division multiplexing (COFDM) as their modulation method. COFDM uses a large number of very low-bandwidth signals. Accordingly, synchronization of multiple transmitters is known to be fairly easy. Digital Video Broadcasting—Terrestrial (“DVB-T”, used in Europe and many other areas) and Integrated Services Digital Broadcasting—Terrestrial (“ISDB-T”, used in Japan and soon Brazil) both use COFDM and may be considered well-suited to SFN operation.

The SFN broadcasting technique conserves the electromagnetic spectrum by expanding geographic coverage on a single frequency band and allows broadcasting networks to fill spatial “gaps” in a given broadcast, thereby improving the level of spatial coverage in a given area to nearly one hundred percent. The probability that a reflected signal will reach behind a signal obstruction is enhanced when transmit diversity is properly employed.

In order for the SFN broadcasting technique to be effective, all signals broadcast by all transmitters must be synchronized in time, frequency and content. This limitation imposes the following constraints on equipment design: frequency synchronization; time synchronization; and content synchronization. According to the frequency synchronization constraint, all local oscillators within elements (e.g., modulators, up-converters) of a transmitter chain must be frequency locked and phase locked to a common reference with high stability. This common reference is generally realized using a GPS receiver at each transmit site. The time synchronization constraint generally requires that each transmitter broadcast the n^{th} symbol of information at a specific time Tₙ, using a very high time resolution to carefully and accurately define the time Tₙ. Typically, the time resolution employed is about plus or minus one microsecond. Time resolution of ±1 μs is often difficult to achieve given the distances between the transmitters and the source of the signal, known as the “headend”. The content synchronization constraint mandates the transmission of the same symbol at the same time from all transmission sites. For this reason, all carrier signals in the modulators of the transmit sites have to be identically modulated, which means that the same bits should modulate the same k^{th} carrier in OFDM multi-carrier based systems, assuming that OFDM is the modulation technique employed.

A DVB-T transport stream, which is known to be a suitable signal for the SFN broadcasting technique, is made up of frames of packets containing video encoded using the known MPEG-2 standard, published by the Moving Picture Experts Group (MPEG). Several different modes of DVB-T exist, each mode defined by the number of video frames that are used to form a single transport stream packet.

As will be familiar to a person of ordinary skill, a DVB-T transport stream typically carries a series of 188-byte MPEG-2 transport stream (TS) packets, each MPEG-2 TS packet comprising 184 bytes of payload data prefixed by a four-byte, i.e., 32-bit, header.

The header begins with a field for holding a sync byte that contains a synchronization code with a value of 0x47. The field for holding the sync byte is followed by a one-bit field for holding a transport error indicator that, when set, indicates the presence of at least one bit error in the packet. The following one-bit filed is for holding a payload start indicator that, when set, indicates that the payload data of the packet is the start of a Packetised Elementary Stream (PES) packet. The following one-bit filed is for holding a transport priority bit. The field for holding the transport priority bit is followed by a field for holding a 13-bit Packet Identifier (PID) value. The PID value is used to identify the PES to which the data in the payload belongs. Some PID values are predefined and are used to indicate various streams of control information. The particular PID value of 0x1FFF is reserved to indicate that the packet is a null packet. The field for holding the PID value is followed by a field for holding two scrambling control bits, which are used by conditional access procedures to encrypt the payload of some TS packets. After the field for holding the scrambling control bits comes a field for holding two adaptation field control bits. The adaptation field control bits relate to the presence of an adaptation field in the payload of the packet. In general, the adaptation field has a fixed structure and occupies a portion of the payload directly following the header. Four values are available for the adaptation field control bits: “01”, indicating no adaptation field, payload only; “10”, indicating adaptation field only, no payload; “11”, indicating an adaptation field followed by payload; and “00”, which is reserved for future use. The adaptation field control bits are followed by a four-bit Continuity Counter.

An exemplary use for the adaptation field is carriage of a Program Clock Reference (PCR) stamp. A PCR stamp is a snapshot of a counter that is driven by a program clock. In some applications, a PCR stamp is inserted into a packet within a transport stream at more or less regular intervals. PCR stamps provide a means for a digital TV receiver to lock its decoded video output to the video source present at the input to an encoder. At the encoder, the program clock is locked to incoming video. Since standard definition video can be referenced to a 27 MHz clock, the frequency for the program clock is often also selected as 27 MHz.

An exemplary packet carrying both a PCR stamp and some payload would have the adaptation field control bits of the packet header set at a value of “11”. Additionally, such a packet would have a PCR flag, in a predetermined location in the adaptation field, set to indicate that a PCR stamp is present.

In order to fulfill the time synchronization constraint and the content synchronization constraint, conventional solutions employ a SFN adapter located at the headend of the system. The SFN adapter forms a megaframe of transport stream packets and inserts, within the megaframe, a Megaframe Initialization Packet (MIP) with a dedicated PID value. The dedicated PID value allows a receiver to recognize that a given packet is a MIP and not a regular packet with a regular PID value. Inserted anywhere within a megaframe of index M, the MIP of that megaframe, MIPM, allows a receiving entity to uniquely identify the starting point (i.e., the first packet) of the megaframe of index M+1. The conveyance of such starting point information is accomplished using a pointer carried by MIPM to indicate the position of the pointer with reference to the start of the megaframe of index M+1. The time difference between the latest pulse of a one-pulse-per-second reference signal that precedes the start of the megaframe of index M+1 and the actual start (i.e., the first bit of the first packet) of the megaframe of index M+1 is included as a parameter in MIPM. This parameter is called a Synchronisation Time Stamp (STS).

Notably, the transport streams provided by the headend are increasingly being designed to comply to the known Asynchronous Serial Interface (ASI) specification, see Digital Video Broadcasting (DVB); Professional Interfaces: Guidelines for the implementation and usage of the DVB Asynchronous Serial Interface (ASI), ETSI TR 101 891, V1.1.1, February 2001, available at www.etsi.org. Unfortunately, the use of ASI-compliant transport streams places limitations on the types of modulators and communications links that can be employed within a SFN distribution system. It would be desirable to have an SFN broadcast system that does not suffer from these limitations and can be used with any modulator or communications link.

### SUMMARY

An ASI-compliant transport stream is processed in a way that allows the use, within a SFN distribution system, of types of modulators and communications links that would otherwise not be suitable. The processing involves disguising null packets by changing the PID value of each null packet. The processing may also involve amending each packet that contains a PCR stamp to hide the presence of the PCR stamp. As a result, none of the packets in the processed transport stream are recognized, by elements of the communications link, as a null packet or as a packet containing a PCR stamp. Accordingly, such packets are considered, by elements of the communications link, to be packets carrying payload. Advantageously, then, packets that would normally be removed or modified by elements of the communications link pass through without being removed or modified.

According to an aspect of the present invention, there is provided a method of adapting a transport stream for transmission to transmitters in a single-frequency network. The method includes receiving a packet, the packet having a header, the header having a field for a packet identifier, and determining whether the packet is a null packet. If the packet is a null packet, the method further includes amending the header to provide, in the field for the packet identifier, a predetermined value, thereby generating an amended packet, where the predetermined value is distinct from a value associated with null packets in a standard, and transmitting the amended packet. In additional aspects of the invention, a headend is provided, including an adapter for carrying out this method and a computer readable medium is provided for adapting the adapter in the headend to carry out this method.

According to another aspect of the present invention, there is provided a method of receiving, at a transmitter in a single-frequency network, a transport stream adapted for transmission to the transmitter. The method includes receiving a packet, the packet having a header, the header having a field for a packet identifier and determining whether the packet is a null packet. If the packet is a null packet, the method further includes amending the header to provide, in the field for the packet identifier, a value associated with null packets in a standard, thereby generating an amended packet, and transmitting the amended packet. In additional aspects of the invention, a transmitter is provided, including an adapter for carrying out this method and a computer readable medium is provided for adapting the adapter in the transmitter to carry out this method.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

Reference will now be made to the drawings, which show by way of example, embodiments of the invention, and in which:

FIG. 1 is a block diagram illustrating a circuit topology of a conventional solution to transmit diversity SFN systems;

FIG. 2 is a block diagram illustrating a circuit topology of an example embodiment of the present invention;

FIG. 3 illustrates steps of an exemplary method of adapting a transport stream for transmission to transmitters in a single-frequency network according to an embodiment of the present invention; and

FIG. 4 illustrates steps of an exemplary method of receiving a transport stream adapted for transmission to transmitters in a single-frequency network according to an embodiment of the present invention.

### DETAILED DESCRIPTION OF THE EMBODIMENTS

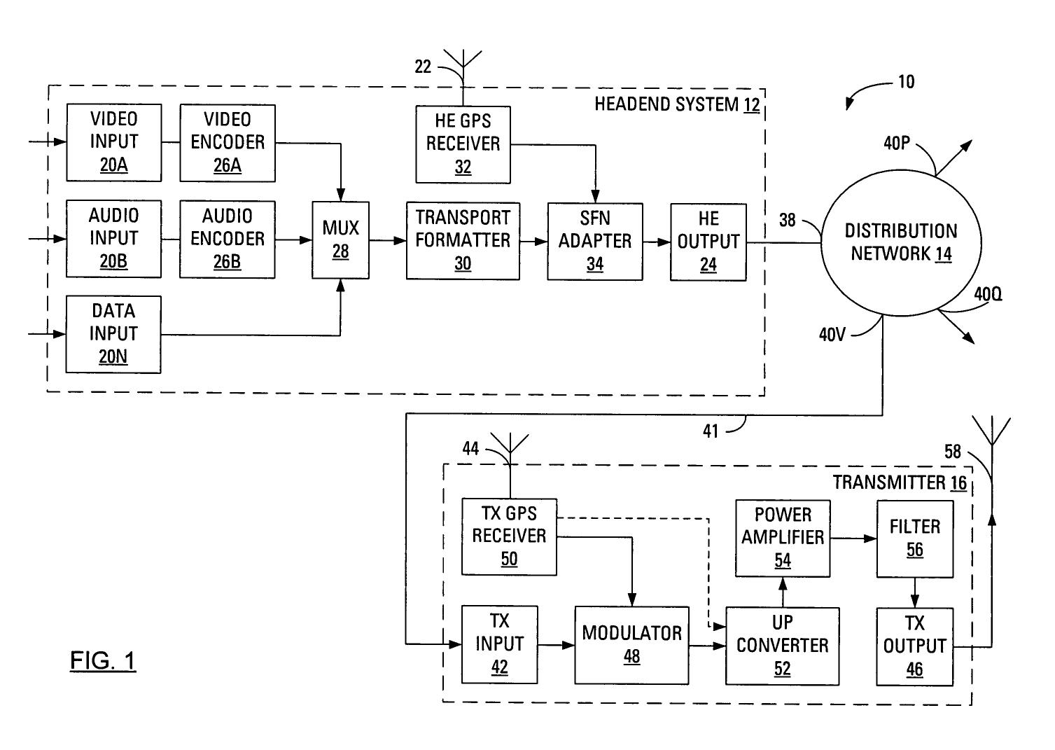

FIG. 1 illustrates, as a block diagram, a circuit topology or system 10 representative of a conventional SFN system. The circuit topology 10 generally comprises a headend system 12, a distribution network 14 and two or more transmitters 16. Only one transmitter 16 is illustrated for simplicity of presentation.

The headend system 12 has a number of input ports, including a video input port 20A, an audio input port 20B and a data input port 20N (collectively or individually referred to by reference numeral 20). The headend system 12 also has a number of encoders. The encoders (collectively or individually referred to by reference numeral 26) may, for example, include: a video encoder 26A, arranged to receive an output signal from the video input port 20A; and an audio encoder 26B, arranged to receive the output signal from the audio input port 20B. A multiplexer 28 is arranged to receive output from the video encoder 26A, the audio encoder 26B and the data input port 20N. The headend system 12 has a transport formatter 30 that is arranged to receive an output signal from the multiplexer 28. The transport formatter 30 includes a Forward Error Correction (FEC) encoder. The headend system 12 has a headend GPS antenna 22 and a headend GPS receiver 32 that is arranged to receive a signal received by the headend GPS antenna 22. An SFN adapter 34 is arranged to receive output from the headend GPS receiver 32 and from the transport formatter 30. Output from the SFN adapter 34 is provided to a headend output port 24.

The headend output port 24 is coupled to a distribution network input port 38. The distribution network 14 has a number of distribution network output ports, individually indicated as 40P, 40Q and 40V, for providing a received transport stream to the transmitters 16. While one transmitter 16 is shown by way of example, it will be understood by those skilled in the art that multiple transmitters are typically coupled to the distribution network 14.

The illustrated transmitter 16 has a transmitter input port 42 that is arranged to receive the transport stream provided, over a connection 41, by the distribution network output port 40V. The connection 41 may be an optical cable link, a radio frequency (RF) link or any other suitable link known to those skilled in the art. The transmitter 16 further has a transmitter GPS antenna 44 that is arranged to receive a GPS signal and pass the GPS signal to a transmitter GPS receiver 50.

The transmitter GPS receiver 50 is arranged to pass the received GPS signal to a modulator 48, which modulator 48 is also arranged to receive the transport stream provided to the transmitter input port 42. The modulator 48 is arranged to provide its output to the up converter 52. The modulator 48 may, for example, be adapted for modulating a received signal using OFDM or Quadrature Amplitude Modulation (QAM). In one embodiment, the modulator 48 is a DVB-T/H modulator specifically adapted for producing a COFDM waveform.

The up converter 52 is arranged to supply an output signal to a power amplifier 54. The power amplifier 54 is arranged to provide a signal to a filter 56. In one example, the filter 56 is a cavity filter. The cavity filter 56 is arranged to supply a final signal to a transmitter output port 46, which, in turn, passes the final signal to a broadcasting antenna 58.

In typical operation of the circuit topology 10 of FIG. 1, the headend input ports 20 receive source signals to be broadcast at the broadcasting antenna 58. In particular, the video input port 20A receives a video signal, the audio input port 20B receives an audio signal and the data input port 20N receives a data signal. Furthermore, the video encoder 26A receives the video signal from the video input port 20A and the audio encoder 26B receives the audio signal from the audio input port 20B. The multiplexer 28 receives an encoded video signal from the video encoder 26A, an encoded audio signal from the audio encoder 26B and the data signal received at the data input port 20N. The multiplexer 28 then provides a multiplexed ASI content signal to the transport formatter 30. The transport formatter 30 formats the ASI content signal to generate a transport stream and passes the transport stream to the SFN adapter 34.

The headend GPS antenna 22 receives a GPS signal. The headend GPS receiver 32 receives the GPS signal from the headend GPS antenna 22 and provides timing information to the SFN adapter 34. More particularly, the headend GPS receiver 32 provides the SFN adapter 34 with a 10 MHz reference signal and a one-pulse-per-second timing signal.

The SFN adapter 34 receives the transport stream from the transport formatter 30, organizes the transport stream packets to form megaframes, generates a MIP for every megaframe and inserts the MIP as one of the packets among the transport stream packets in each megaframe. The SFN adapter 34 derives timing information required for the generation of the MIP from the reference signal and the timing signal received from the headend GPS receiver 32. The SFN adapter 34 includes the timing information in each MIP to convey, to each transmitter 16, a correct starting time for each megaframe, as well as to convey data timing.

Optionally, the SFN adapter 34 adds null packets to provide an exact output bit rate for the transport stream to be transmitted at the headend output port 24. The output bit rate may be selected based on a particular operation mode required by a service provider operating the circuit topology 10 of FIG. 1. Many service providers use an operation mode specified by a DVB standard. Popular DVB standards include a DVB standard (DVB-T) used for delivering video to terrestrial devices and a DVB standard (DVB-H) used for delivering video to handheld devices.

Notably, the SFN adapter 34 assigns a predetermined PID value (0x1FFF) to each null packet so that the null packets may be recognized, downstream, as null packets.

The SFN adapter 34 provides an output transport stream to the headend output port 24 for transmission. The headend output port 24 passes the output transport stream to the distribution network input port 38.

In the distribution network 14, the transport stream is distributed to the distribution network output ports 40P, 40Q, 40V, from which the transport stream is communicated to the transmitters.

The transmitter 16 receives the encoded transport stream, recovers the MIPs and uses the information contained in the MIPs, in conjunction with information contained in a received GPS signal, to accomplish time synchronization and bit synchronization with the other transmitters in the SFN network 10. In particular, the transmitter input port 42 receives the transport stream provided by the distribution network output port 40V over the connection 41. The transmitter input port 42 passes the transport stream to the modulator 48.

The transmitter GPS antenna 44 receives a GPS signal. The transmitter GPS receiver 50 receives the GPS signal from the transmitter GPS antenna 44 and provides the 10 MHz reference signal and the one-pulse-per-second timing signal to the modulator 48 and, perhaps, the up converter 52.

The modulator 48 modulates the transport stream using OFDM, QAM, or another modulation technique known in the art. The modulator 48 then provides a modulated transport stream to the up converter 52. The up converter 52 up-converts the modulated transport stream to a predetermined carrier frequency. The up converter 52 supplies the up-converted transport stream to the power amplifier 54, which amplifies the up-converted transport stream to achieve a predetermined broadcast power. The power amplifier 54 provides an amplified transport stream to the cavity filter 56. The cavity filter 56 filters the amplified transport stream and supplies a filtered transport stream, suitable for broadcasting, to the transmitter output port 46, which passes the filtered transport stream to the broadcasting antenna 58.

To properly handle the case wherein the transport stream, passed from the distribution network 14 to the transmitter 16 over the associated connection 41, is ASI-compliant, it is expected that the following conditions will be met by the infrastructure of the distribution network 14 and the associated connection 41.
(a) The sequence and content of all bits and packets in the transport stream, including null packets, output at the headend output port 24 should not be modified by the distribution network 14 or the connection 41. If some packets are added by the distribution network 14 or elements of the connection 41, the added packets should be removed prior to the arrival of the transport stream at the modulator 48 at the output of the transmitter input port 42.
(b) Any delay in delivery of the transport stream output at the headend output port 24 to the transmitter input port 42 should be constant for all transmitters 16.
(c) The output bit rate of the headend output port 24 should match the input bit rate expected by the transmitter input port 42 (i.e., the bit rate required by the modulator 48). These output and input bit rates are locked to the 10 MHz reference from the GPS receivers 32 and 50.

In the case wherein the connection 41 is an RF link, these conditions may be difficult to meet. To meet the conditions outlined above, the modulator of the RF link is required to provide a mode of operation in which the output bit rate of the RF link modulator is synchronized to the bit rate of the incoming transport stream provided by the headend output port 24. Conventional QAM modulators, and other types of modulators, do not typically provide this mode of operation. Conventional modulators are known to remove null packets from a received transport stream and control the addition of further null packets in order to support a predetermined bit rate. Conventional modulators are also known to utilize PCR re-stamping because of the added null packets. As a result, the conditions described above discourage the use of an RF link for the connection 41.

In overview, to mitigate the difficulty present when attempting to use an RF link for the connection 41, the transport stream may be processed at the headend to disguise null packets and packets that carry a PCR stamp. Since conventional modulators would not recognize disguised null packets, the null packets are not removed by the RF link modulator. Similarly, since conventional modulators would not recognize disguised packets carrying a PCR stamp, the PCR stamp is not re-stamped by the RF link modulator.

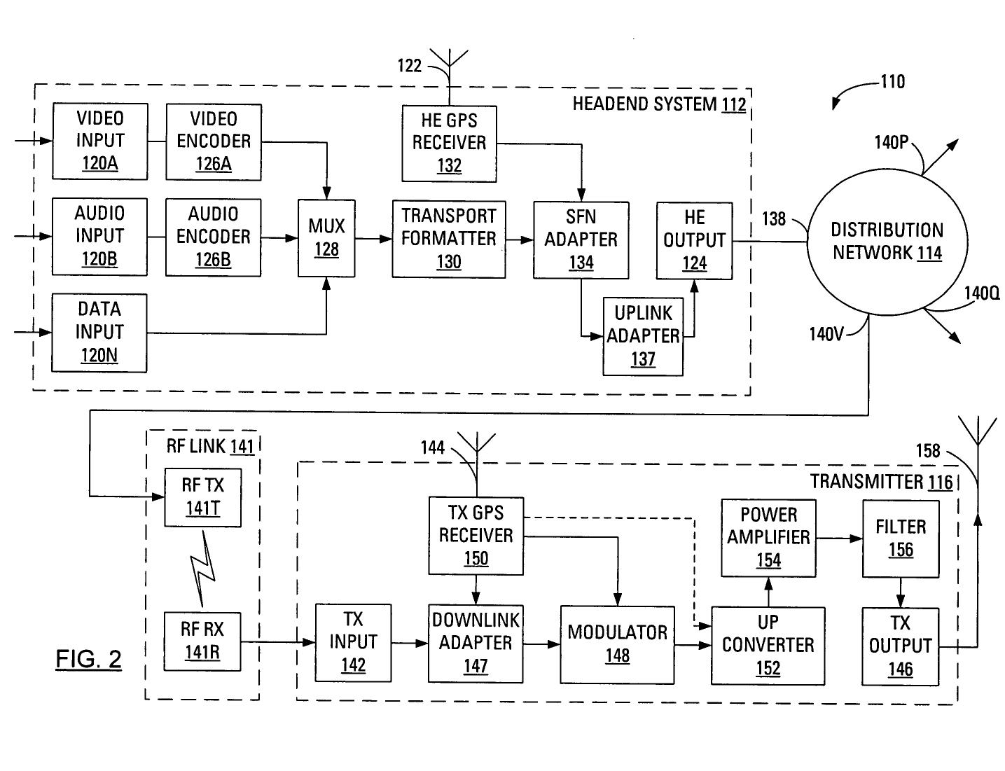

FIG. 2 illustrates, as a block diagram, a circuit topology or system 100 representative of a novel SFN system in accordance with an aspect of the present invention. The circuit topology 100 generally comprises a headend system 112, a distribution network 114 and two or more transmitters 116. Only one transmitter 116 is illustrated for simplicity of presentation.

The headend system 112 has a number of input ports, including a video input port 120A, an audio input port 120B and a data input port 120N (collectively or individually referred to by reference numeral 120). The headend system 112 also has a number of encoders. The encoders (collectively or individually referred to by reference numeral 126) may, for example, include: a video encoder 126A, arranged to receive an output signal from the video input port 120A; and an audio encoder 126B, arranged to receive the output signal from the audio input port 120B. A multiplexer 128 is arranged to receive output from the video encoder 126A, the audio encoder 126B and the data input port 120N. The headend system 112 has a transport formatter 130 that is arranged to receive an output signal from the multiplexer 128. The transport formatter 130 includes a FEC encoder. The headend system 112 has a headend GPS antenna 122 and a headend GPS receiver 132 that is arranged to receive a signal received by the headend GPS antenna 122. An SFN adapter 134 is arranged to receive output from the headend GPS receiver 132 and from the transport formatter 130. Output from the SFN adapter 134 is supplied to an uplink adapter 137. The uplink adapter 137 receives an output transport stream from the SFN adapter 134 and provides the output transport stream to a headend output port 124.

The headend output port 124 is coupled to a distribution network input port 138. The distribution network 114 has a number of distribution network output ports, individually indicated as 140P, 140Q and 140V, for providing a received transport stream to the transmitters. While one transmitter 116 is shown by way of example, it will be understood by those skilled in the art that multiple transmitters are typically coupled to the distribution network 114.

It will be understood by those skilled in the art that the distribution network 114 may be implemented in a number of ways. In one example, the distribution network 114 is a cable system. In another example, the distribution network 114 is comprised of a geostationary satellite with corresponding links to the transmitters 116, which are repeaters that receive the transport stream from the satellite.

An RF link 141 is illustrated as connecting the distribution network output port 140V to the illustrated transmitter 116. The RF link 141 includes an RF link transmitter 141T, which is connected to the distribution network output port 140V, and an RF receiver 141R, which is connected to a transmitter input port 142 of the transmitter 116.

It will be understood by those skilled in the art that any number of transmitters 116 may be coupled to the distribution network 114. All of the transmitters 116 may be connected to the distribution network 114 with wireless connections similar to the RF link 141 or a combination of various types of connections may be employed.

The transmitter 116 further has a transmitter GPS antenna 144 that is arranged to receive a GPS signal and pass the GPS signal to a transmitter GPS receiver 150. A downlink adapter 147 is arranged to receive output from the transmitter input port 142 and signals from the transmitter GPS receiver 150.

The downlink adapter 147 then provides output to a modulator 148.

The modulator 148 provides a modulated signal to an up converter 152, which also receives timing information from the transmitter GPS receiver 150, and up-converts the modulated signal to a predetermined carrier frequency.

The up converter 152 is arranged to supply an output signal to a power amplifier 154. The power amplifier 154 is arranged to provide a signal to a filter 156. In one example, the filter 156 is a cavity filter. The cavity filter 156 is arranged to supply a final signal to a transmitter output port 146, which, in turn, passes the final signal to a broadcasting antenna 158.

In typical operation of the circuit topology 100 of FIG. 2, the headend input ports 120 receive source signals to be broadcast at the broadcasting antenna 158. In particular, the video input port 120A receives a video signal, the audio input port 120B receives an audio signal and the data input port 120N receives a data signal. Furthermore, the video encoder 126A receives the video signal from the video input port 120A and the audio encoder 126B receives the audio signal from the audio input port 120B. The multiplexer 128 receives an encoded video signal from the video encoder 126A, an encoded audio signal from the audio encoder 126B and the data signal received at the data input port 120N. The multiplexer 128 then provides a multiplexed ASI content signal to the transport formatter 130. The transport formatter 130 formats the ASI content signal to generate a transport stream and passes the transport stream to the SFN adapter 134.

The headend GPS antenna 122 receives a GPS signal. The headend GPS receiver 132 receives the GPS signal from the headend GPS antenna 122 and provides timing information to the SFN adapter 134. More particularly, the headend GPS receiver 132 provides the SFN adapter 134 with a 10 MHz reference signal and a one-pulse-per-second timing signal.

The SFN adapter 134 receives the transport stream from the transport formatter 130, organizes the transport stream packets to form megaframes, generates a MIP for every megaframe and inserts the MIP as one of the packets among the transport stream packets in each megaframe. The SFN adapter 134 derives timing information required for the generation of the MIP from the reference signal and the timing signal received from the headend GPS receiver 132. The SFN adapter 134 includes the timing information in each MIP to convey, to each transmitter 116, a correct starting time for each megaframe, as well as to convey data timing.

Optionally, the SFN adapter 134 adds null packets to provide an exact output bit rate for the transport stream to be transmitted at the headend output port 124. The output bit rate may be selected based on a particular operation mode required by a service provider operating the circuit topology 100 of FIG. 2.

Notably, the SFN adapter 134 assigns a predetermined PID value (0x1FFF) to each null packet so that the null packets may be recognized, downstream, as null packets.

The SFN adapter 134 provides an output transport stream to the uplink adapter 137 with an encoded transport stream. The uplink adapter 137 performs any needed conditioning to the encoded transport stream to adapt the encoded transport stream for handling by elements responsible for wireless transmission from the distribution network 114 to the transmitter 116. The operation of the uplink adapter 137 will be described in further detail below. The uplink adapter 137 then passes the conditioned transport stream to the headend output port 124 for transmission. The headend output port 124 passes the conditioned transport stream to the distribution network input port 138.

In the distribution network 114, the transport stream is distributed to the distribution network output ports 140P, 140Q, 140V, from which the transport stream is communicated to the transmitters. In particular, the transport stream departs the distribution network 114 via the distribution network output port 140V for transmission over the RF link 141 to the transmitter 116.

Within the RF link 141, a modulator in the RF link transmitter 141T processes the transport stream before the RF link transmitter 141T transmits the processed transport stream to the RF link receiver 141R. We assume that the modulator in the RF link transmitter 141T works in a conventional mode by modifying the transport stream to add null packets, thereby providing a required symbol rate (i.e., bit rate) for the transmission to the RF link receiver 141R.

The transmitter 116 receives the transport stream from the RF link receiver 141R, recovers the MIPs and uses the information contained in the MIPs, in conjunction with information contained in a received GPS signal, to accomplish time synchronization and bit synchronization with the other transmitters in the SFN network 100.

In particular, the transmitter input port 142 receives the transport stream provided by the distribution network output port 140V over the RF link 141. The transmitter input port 142 passes the received transport stream to the downlink adapter 147.

The transmitter GPS antenna 144 receives a GPS signal. The transmitter GPS receiver 150 receives the GPS signal from the transmitter GPS antenna 144 and provides the 10 MHz reference signal and the one-pulse-per-second timing signal to the downlink adapter 147, the modulator 148 and, perhaps, the up converter 152.

The downlink adapter 147 uses the reference signal and timing signal received from the transmitter GPS receiver 150 while removing the conditioning added to the transport stream by the uplink adapter 137. The downlink adapter 147 then passes the transport stream, with conditioning removed, to the modulator 148.

The modulator 148 uses the PCR stamp, as well as the information provided by the transmitter GPS receiver 150, when modulating the transport stream signal using COFDM, OFDM, QAM or any other suitable modulation technique known in the art, to ensure that all transmitters within the SFN system 100 are synchronized.

The modulator 148 then provides a modulated transport stream to the up converter 152. The up converter 152 up-converts the modulated transport stream to a predetermined carrier frequency. The up converter 152 supplies the up-converted transport stream at the predetermined carrier frequency to the power amplifier 154, which amplifies the up-converted transport stream to achieve a predetermined broadcast power. The power amplifier 154 provides an amplified transport stream to the cavity filter 156. The cavity filter 156 filters the amplified transport stream and supplies a filtered transport stream, suitable for broadcasting, to the transmitter output port 146, which passes the filtered transport stream to the broadcasting antenna 158.

In one embodiment of the present invention, the uplink adapter 137 and the downlink adapter 147 process the ASI transport stream in a way that allows the use of the RF link 141 to connect the distribution network 114 to the transmitter 116.

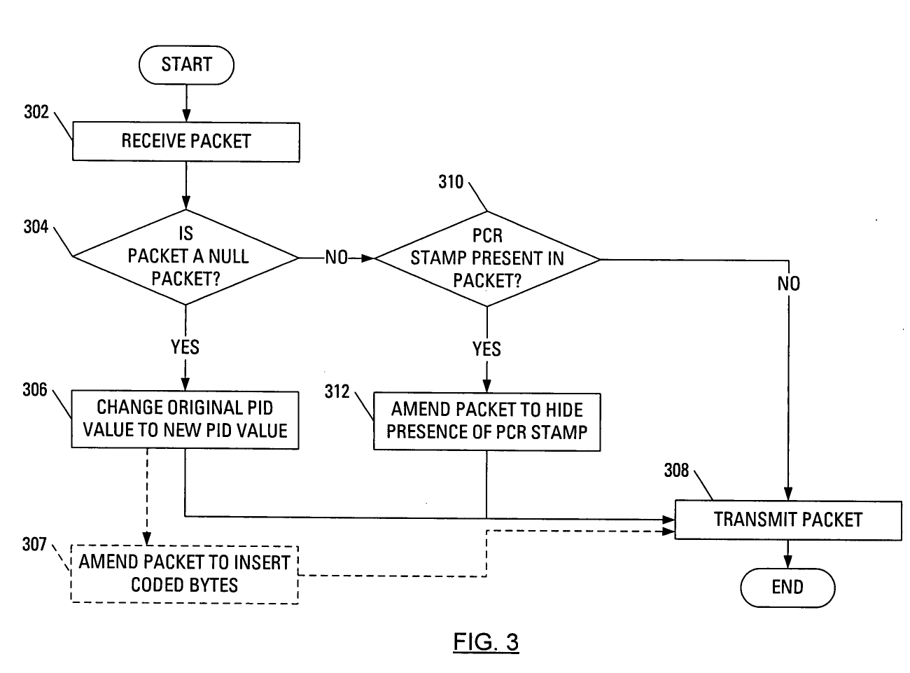

FIG. 3 illustrates steps of an exemplary method of adapting a transport stream for transmission to transmitters in an SFN according to an embodiment of the present invention.

In operation, the uplink adapter 137 receives (step 302) a packet from the transport formatter 130. The uplink adapter 137 then determines (step 304) whether the packet is a null packet, e.g., the uplink adapter 137 determines whether the packet has a PID value of 0x1FFF. If the uplink adapter 137 determines (step 304) that the packet is a null packet, the uplink adapter 137 changes (step 306) the original PID value (0x1FFF) to a new PID value. The new PID value is arranged, a priori in a manner specific to the uplink adapter 137 and the downlink adapter 147, to designate null packets. The uplink adapter 137 then transmits (step 308) the packet to the headend output port 124.

In the event that the uplink adapter 137 determines (step 304) that the packet is not a null packet, the uplink adapter 137 further determines (step 310) whether a PCR stamp is present in the packet.

As per the MPEG-2 specification, if a PCR stamp is present in a given packet, the PCR stamp is located at a particular location within the given packet. In particular, the PCR stamp is located at a particular location within the adaptation field of the given packet. Even more particularly, the PCR stamp is located at a specific offset from the sync byte in the header of the packet and has 42 bits, six of which are reserved. To determine (step 310) whether a PCR stamp is present in the packet, the uplink adapter 137 first determines, from the adaptation field control bits, that the packet has an adaptation field. Secondly, the uplink adapter 137 determines that a PCR flag, in a predetermined location in the adaptation field, is set to indicate that a PCR stamp is present.

Upon determining (step 310) that a PCR stamp is present in the packet, the uplink adapter 137 amends (step 312) the packet to hide the presence of the PCR stamp. In particular, the uplink adapter 137 changes the value of the adaptation field control bits of the header of the packet. Further particularly, the uplink adapter 137 replaces the original value for the two adaptation field control bits with a new value for the two adaptation field control bits. A preferred new value for the two adaptation field control bits is the value “00”, which, as has been discussed above, is a reserved value. Additionally, the uplink adapter 137 records the original value for the two adaptation field control bits in the two least significant bits of the six reserved bits of the PCR stamp in the adaptation field of the packet. The uplink adapter 137 then transmits (step 308) the packet to the headend output port 124.

Given that every packet that carries a PCR stamp has an adaptation field, then the two possibilities for the original value for the two adaptation field control bits are “10” and “11”. Since there is no variation in the first adaptation field control bit, the downlink adapter 147 need not record both of the bits in the original value for the two adaptation field control bits. It may be considered adequate to record only the second adaptation field control bit in the least significant bit of the six reserved bits of the PCR stamp in the adaptation field of the packet.

Upon determining (step 310) that a PCR stamp is not present in the packet, the uplink adapter 137 transmits (step 308) the packet to the headend output port 124.

As a result of the processing of the null packets and the PCR stamp-carrying packets of the ASI transport stream, the modulator used in the RF link 414 for ASI transport stream distribution, i.e., the modulator (not shown) in the RF link transmitter 141T, does not recognize any of the packets in the ASI transport stream as a null packet or as a packet containing a PCR stamp. Accordingly, all null packets and all packets containing a PCR stamp are considered, by the modulator within the RF link transmitter 141T, to be packets carrying payload. Advantageously, then, packets that would normally be removed or modified by the modulator in the RF link transmitter 141T, i.e., null packets and PCR-stamp-containing packets, pass through the modulator within the RF link transmitter 141T without being removed or modified.

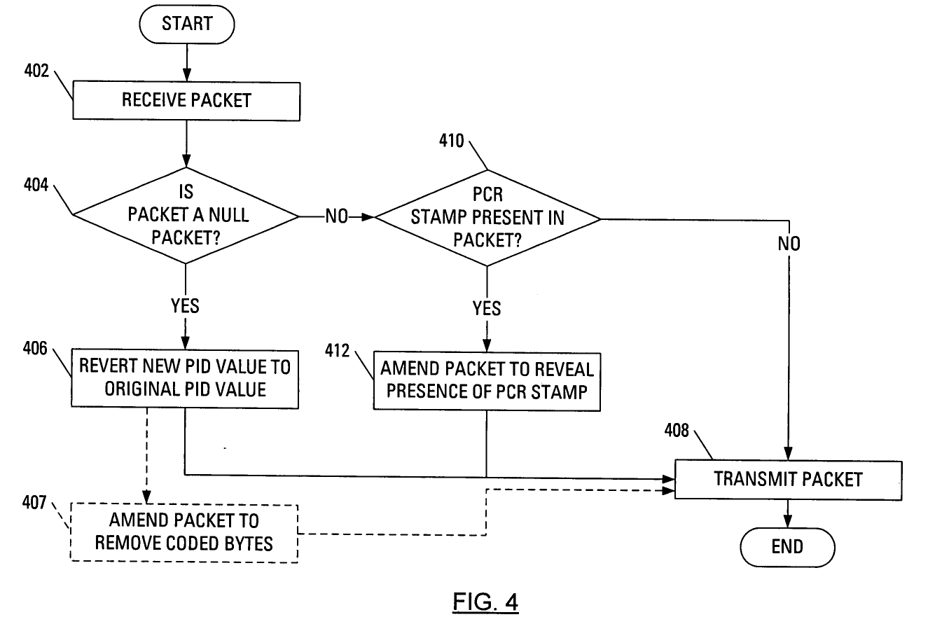

FIG. 4 illustrates steps of an exemplary method of receiving a transport stream adapted for transmission to transmitters in a single-frequency network according to an embodiment of the present invention.

The downlink adapter 147 receives (step 402) a packet from the transmitter input port 142. The downlink adapter 147 then determines (step 404) whether the packet is a null packet, e.g., the downlink adapter 147 determines whether the packet has the new PID value arranged for use by the uplink adapter 137 for specifying null packets. If the downlink adapter 147 determines (step 404) that the packet is a null packet, the downlink adapter 147 changes (step 406) the new PID value to the original PID value (0x1FFF). The downlink adapter 147 then transmits (step 408) the packet to the modulator 148.

In the event that the downlink adapter 147 determines (step 404) that the packet is not a null packet, the downlink adapter 147 further determines (step 410) whether a PCR stamp is present in the packet.

According to the manner in which each packet carrying a PCR stamp has been amended (step 312) to hide the presence of the PCR stamp, determining (step 410) whether a PCR stamp is present in the packet involves determining whether the two adaptation field control bits have the value “00”.

As per the MPEG-2 specification, if a PCR stamp is present in a given packet, the PCR stamp is located at a particular location within the adaptation field of the given packet. More particularly, the PCR stamp is located at a specific offset from the sync byte in the header of the packet and has 42 bits, six of which are reserved. To determine (step 310) whether a PCR stamp is present in the packet, the uplink adapter 137 first determines, from the adaptation field control bits, that the packet has an adaptation field. Secondly, the uplink adapter 137 determines that a PCR flag, in a predetermined location in the adaptation field, is set to indicate that a PCR stamp is present.

Upon determining (step 410) that a PCR stamp is present in the packet, the downlink adapter 147 amends (step 412) the packet to reveal the presence of the PCR stamp. In particular, the downlink adapter 147 changes the value of the adaptation field control bits of the header of the packet. Further particularly, the downlink adapter 147 replaces the “00” value for the two adaptation field control bits with the original value for the two adaptation field control bits. The original value for the two adaptation field control bits is obtained by the downlink adapter 147 by reading the two least significant bits of the six reserved bits of the PCR stamp in the adaptation field of the packet. The downlink adapter 147 then transmits (step 408) the packet to the modulator 148.

Upon determining (step 410) that a PCR stamp is not present in the packet, the downlink adapter 147 transmits (step 408) the packet to the modulator 148.

It is possible that the new PID value that has been arranged to designate null packets already exists inside the MPEG-2 transport stream. Optionally, then, to distinguish the disguised null packets with the new PID value from the packets inside the MPEG-2 transport stream having the same PID value, the uplink adapter 137 amends the null packets that have been assigned the new PID value to provide a series of coded bytes. As described above, determining (step 404) whether a received packet is a null packet involved identifying those packets with the new PID value. In this optional alternative, determining (step 404) whether a received packet is a null packet involves the downlink adapter 147 recognizing packets with the coded bytes.

For example, in the method of FIG. 3, after changing (step 306) the original PID to the new PID value, the uplink adapter 137 also codes (step 307) bytes 4, 5, 6 and 7 of the packet as 0x55, 0xAA, 0x55 and 0xAB, respectively. The downlink adapter 147 is adapted to recognize the predetermined pattern of bytes when determining (step 404) whether a received packet is a null packet. That is, when the downlink adapter 147 receives a packet with the PID value that has been arranged to disguise null packets, the task of determining (step 404) whether a received packet is a null packet is not complete. The downlink adapter 147 also considers bytes 4, 5, 6 and 7. If the downlink adapter 147 finds the pattern 0x55, 0xAA, 0x55, 0xAB in those bytes, the downlink adapter 147 proceeds to change (step 406) the new PID value to the original PID value (0x1FFF). The downlink adapter 147 also amends (step 407) the packet to remove the coded bytes. The downlink adapter 147 then transmits (step 408) the packet to the modulator 148.

It should be clear that the above exemplary number of coded (modified) bytes and the specific code has been selected arbitrarily and it is merely necessary that the downlink adapter 147 be programmed to recognize a coded packet.

In one embodiment, the bit rates of the uplink adapter 137 and the downlink adapter 147 are locked to the 10 MHz reference provided by the GPS receivers 132 and 150, respectively.

One aspect of the present invention provides the flexibility to distribute an ASI-compliant transport stream wirelessly and deploy a DVB-T/H SFN network. In one embodiment, the functionality of the uplink adapter 137 could be implemented as part of an SFN adapter, such as the SFN adapter 134, by making coding or software changes and/or additions to the hardware responsible for implementing the functionality of the SFN adapter 134.

It will be understood by those skilled in the art that aspects of the invention are not limited to overcoming the limitations of an RF link. For instance, an Ethernet link may present similar limitations to those presented by an RF link. Accordingly, aspects of the present invention may be implemented to overcome the limitations presented by use of an Ethernet link between the distribution network 114 and the transmitter 116.

It will also be understood by those skilled in the art that the internal configuration of various components of the present invention are not illustrated in their entirety. Only components and interconnections that are needed to explain the functioning of the present invention have been illustrated.

The above-described embodiments of the present application are intended to be examples only. Alterations, modifications and variations may be effected to the particular embodiments by those skilled in the art without departing from the scope of the application, which is defined by the claims appended hereto.

What is claimed is:

1. A method of adapting a transport stream for transmission to transmitters in a single-frequency network, said method comprising:
receiving a packet, said packet having a header, said header having a field for a packet identifier;
determining whether said packet is a null packet;
if said packet is a null packet, amending said header to provide, in said field for said packet identifier, a predetermined value, thereby generating an amended packet, where said predetermined value is distinct from a value associated with null packets in a standard; and
transmitting said amended packet.

2. The method of claim 1 wherein said determining whether said packet is a null packet comprises considering as a null packet any packet having said value associated with null packets in said standard in said field for said packet identifier.

3. The method of claim 1 further comprising, if said packet is a null packet, amending said packet so that said packet includes a plurality of specifically coded bytes.

4. The method of claim 1 further comprising, if said packet is not a null packet:
determining whether said packet carries a program clock reference stamp;
if said packet carries a program clock reference stamp, amending said header to disguise presence of said program clock reference stamp, thereby generating an amended packet; and
transmitting said amended packet.

5. The method of claim 4 wherein said determining whether said packet carries a program clock reference stamp comprises:
determining whether said packet has an adaptation field; and
if said packet has an adaptation field, determining whether a flag, in a predetermined location in said adaptation field, is set to indicate that a program clock reference stamp is present.

6. The method of claim 5 wherein said amending said header to disguise presence of said program clock reference stamp comprises amending said header to disguise presence of said adaptation field.

7. A headend in a single-frequency network comprising:
an adapter adapted to:
receive a packet, said packet having a header, said header having a field for a packet identifier;
determine whether said packet is a null packet;
amend said header to provide, in said field for said packet identifier, a predetermined value, thereby generating an amended packet, where said predetermined value is distinct from a value associated with null packets in a standard; and
transmit said amended packet.

8. A computer readable medium containing computer-executable instructions that, when performed by processor in an adapter in a headend of a single-frequency network, cause said processor to:
receive a packet, said packet having a header, said header having a field for a packet identifier;
determine whether said packet is a null packet;
amend said header to provide, in said field for said packet identifier, a predetermined value, thereby generating an amended packet, where said predetermined value is distinct from a value associated with null packets in a standard; and
transmit said amended packet.

9. A method of receiving, at a transmitter in a single-frequency network, a transport stream adapted for transmission to said transmitter, said method comprising:
receiving a packet, said packet having a header, said header having a field for a packet identifier;
determining whether said packet is a null packet;
if said packet is a null packet, amending said header to provide, in said field for said packet identifier, a value associated with null packets in a standard, thereby generating an amended packet; and
transmitting said amended packet.

10. The method of claim 9 wherein said determining whether said packet is a null packet comprises determining whether a value in said field for said packet identifier is equivalent to a predetermined value for identifying null packets, where said predetermined value is distinct from a value associated with null packets in a standard.

11. The method of claim 10 wherein said determining whether said packet is a null packet further comprises determining whether said packet includes a plurality of specifically coded bytes.

12. The method of claim 9 further comprising, if said packet is not a null packet,
determining whether said packet disguises presence of a program clock reference stamp;
if said packet disguises presence of a program clock reference stamp, amending said header to allow presence of said program clock reference stamp to be determined, thereby generating an amended packet; and
transmitting said amended packet.

13. The method of claim 12 wherein said determining whether said packet disguises presence of a program clock reference stamp comprises determining whether said packet disguises presence of an adaptation field.

14. The method of claim 13 wherein said amending said header to allow presence of said program clock reference stamp to be determined comprises amending said header to indicate presence of said adaptation field.

15. A transmitter in a single-frequency network comprising:
an adapter adapted to:
receive a packet, said packet having a header, said header having a field for a packet identifier;
determine whether said packet is a null packet;
amend said header to provide, in said field for said packet identifier, a value associated with null packets in a standard, thereby generating an amended packet; and
transmit said amended packet

16. A computer readable medium containing computer-executable instructions that, when performed by processor in an adapter in a transmitter in a single-frequency network, cause said processor to:
receive a packet, said packet having a header, said header having a field for a packet identifier;
determine whether said packet is a null packet;
amend said header to provide, in said field for said packet identifier, a value associated with null packets in a standard, thereby generating an amended packet; and
transmit said amended packet.
